(19) United States
(12) Patent Application Publication
(10) Pub. No.: US 2007/0245147 A1
(43) Pub. Date: Oct. 18, 2007

(54) MESSAGE AUTHENTICATION CODE GENERATING DEVICE, MESSAGE AUTHENTICATION CODE VERIFICATION DEVICE, AND MESSAGE AUTHENTICATION SYSTEM

(76) Inventor: Katsuyuki Okeya, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/734,807

(22) Filed: Apr. 13, 2007

(30) Foreign Application Priority Data
Apr. 17, 2006 (JP) 2006-113586

(51) Int. Cl. H04L 9/00

(52) U.S. Cl. 713/181

(57) ABSTRACT

A message authentication technology capable of securing against side channel attack is provided. In a message authentication code generating device for calculating a message authentication code for a message from the message, a process in which disturbance information is generated from a temporary use numerical value, a process in which a conversion message is calculated from the message; and a process in which the message authentication code is calculated from the disturbance information and the conversion message are performed. In the process of calculating the message authentication code, process information is disturbed or concealed by the disturbance information. Therefore, the message authentication which is secure against side channel attack can be realized.

### CROSS-REFERENCE TO RELATED APPLICATION

The present application claims priority from a Japanese Patent Application No. JP 2006-113586 filed on Apr. 17, 2006, the content of which is hereby incorporated by reference into this application.

### BACKGROUND OF THE INVENTION

The present invention relates to an information security technology. More particularly, it relates to an authentication technology using a message authentication code (MAC).

Along with the progress of information communication networks, an encryption technology has become an indispensable element for concealment and authentication of electronic information. Requirements for the encryption technology include process speed, small amount of memory usage and others in addition to security. However, the security, the process speed, and the amount of the memory usage are in a trade-off relation in general. Accordingly, it is difficult to satisfy all the above requirements at the same time.

The encryption technology includes common key cipher and public key cipher. The common key cipher includes a so-called cipher by which a message is encrypted or decrypted and message authentication for verifying authenticity of a message.

In the message authentication, for a given message, a message authentication code (first message authentication code) which is the data showing the authenticity of the given message is generated by using a key. When the authenticity of the message is to be confirmed or verified, a message authentication code (second message authentication code) for a given message is generated again by using the same key as the above-described key, and the authenticity is determined based on whether the above message authentication codes match with each other. The methods for message authentication (especially, OMAC and PMAC) have been described in Document 1: T. Iwata and K. Kurosawa, “OMAC: One-Key CBC MAC” in the proceedings of Fast Software Encryption (FSE 2003), Lecture Notes in Computer Science 2887, Springer-Verlag, pp. 129-153 (2003) and in Document 2: J. Black and P Rogaway, “A Block-Cipher Mode of Operation for Parallelizable Message Authentication” in the proceedings of EUROCRYPT 2002, Lecture Notes in Computer Science 2332, Springer-Verlag, pp. 384-397 (2002).

Moreover, with respect to the security in the encryption technology, resistance to such attacks as that based on mathematical theories including statistical analysis and the side channel attack in which secret information is specified by using physical amounts such as calculating time and a power consumption observed in an encryption device at the encryption has been required. The side channel attack has been described in Document 3: P. C. Kocher, J. Jaffe, and B. Jun, “Differential Power Analysis” in the proceedings of CRYPTO 1999, Lecture Notes in Computer Science 1666, Springer-Verlag, pp. 388-397 (1999).

Moreover, the side channel attack on the message authentication has been described in Document 4: K. Okeya, and T. Iwara, “Side Channel Attacks on Message Authentication Codes” in the proceedings of Security and Privacy in Ad-hoc and Sensor Networks: Second European Workshop, ESAS 2005, Lecture Notes in Computer Science 3813, Springer-Verlag, pp. 205-217, (2005). In the case where there exists the following exclusive-OR (XOR) at the message authentication, that is, in the case where one of two inputs of the exclusive-OR is a fixed value and a secret value for an attacker and the other is a known value for the attacker and may be changed by the attacker, the message authentication has vulnerability against the side channel attack.

### SUMMARY OF THE INVENTION

The authenticity of a message can be verified by using the message authentication in the manner as described above. However, although the technologies described in the above-described documents 1 and 2 have provided message authentication methods, the resistance to the side channel attack has not been fully taken into consideration.

The present invention has been made with taking into account the above-described circumstances, and it provides a message authentication technology for securing against the side channel attack.

The typical ones of the inventions disclosed in this application will be briefly described as follows. The present invention relates to a message authentication technology using a message authentication code (hereinafter, abbreviated as MAC as required) and is characterized by comprising the following technological means.

(1-1) A device (message authentication code generating device) according to the present invention calculates (generates) a message authentication code (MAC: represented by a symbol C or T) from a message (data subjected to message authentication: represented by a symbol M), and this device is characterized in that it is provided with a disturbance information generating unit, a message converting unit, and an authentication code (MAC) calculating unit, and each of the units performs the process corresponding to the unit. The disturbance information generating unit performs a process (disturbance information generating process) of generating disturbance information (represented by a symbol R) by using a temporary use numerical value (nonce: represented by a symbol N). The message converting unit performs a process (message conversion process) of calculating a conversion message (represented by a symbol M′) from the above-described message (M). The authentication code calculating unit performs a process (authentication code calculating process) of calculating the above-described message authentication code (C) from the above-described disturbance information (R) and the above-described conversion message (M′). By this means, a message authentication method capable of securing against side channel attack and a device operating in accordance with the method are realized.

(1-2) Furthermore, in this device, the process for generating the above-described disturbance information (R) may be performed by a process step of encrypting the above-described temporary use numerical value (N) (especially, block encryption (E)).

(1-3) Moreover, in this device, the process for calculating the above-described conversion message (M′) may be performed by a process step of dividing the above-described message (M) into message blocks (represented by a symbol B or M[i]) and encrypting the message blocks (B) (especially, block encryption (E)).

(1-4) Furthermore, in this device, the process for calculating the above-described message authentication code (C) may be performed in accordance with the process for a One-Key CBC MAC (OMAC) and a Parallelizable MAC (PMAC), which are well-known technologies.

In the configuration where the OMAC is applied, for example, in the authentication code calculating unit and the process in the unit, an addition by exclusive-OR or arithmetic addition and an encryption (block encryption) are provided for each of the conversion messages (M′) by the message blocks (B). In this configuration, an addition of a conversion message (M′) by a first message block and disturbance information (R) is calculated, and the calculated output is encrypted to obtain a first process result. Then, an addition of a conversion message (M′) by a second message block and the above-described first process result is calculated, and the calculated output is encrypted to obtain a second process result. Thereafter, through the chain processing in the same manner, an addition of the conversion message (M′) by the m-th message block and the (m−1)-th process result is calculated, and the calculated result is encrypted to obtain an m-th process result as a message authentication code (T).

In the configuration where the PMAC is applied, for example, in the authentication code calculating unit and the process in the unit, a first (first type) addition by exclusive-OR or arithmetic addition, an encryption (block encryption), and a second (second type) addition by exclusive-OR or arithmetic addition are provided for each of the conversion messages (M′) by the message blocks (B). In this configuration, a first addition of a conversion message (M′) by a first message block and γ₁L is calculated, the calculated output is encrypted, and a first process result is obtained by a second addition of the encrypted output and the disturbance information (R). Then, a first addition of a conversion message (M′) by a second message block and γ₂L is calculated, the calculated output is encrypted, and a second process result is obtained by a second addition of the encrypted output and the first process result. Thereafter, through the chain processing in the same manner, a first addition of the conversion message (M′) by the (m−1)-th message block and γₘ₋₁L is calculated, the calculated result is encrypted, and an (m−1)-th process result is obtained by a second addition of the encrypted output and the (m−2)-th process result. Finally, an addition of the conversion message (M′) by the m-th message block and the (m−1)-th process result is calculated, the calculated output is encrypted, and an m-th process result is obtained as a message authentication code (T).

(1-5) Moreover, in this device, the process for calculating the above-described message authentication code (C) may be performed in the following manner. That is, in the authentication code calculating unit and the process in the unit, there are executed the process steps of: generating first intermediate data (d1) through the first addition and the encryption from the above-described conversion message (M′); generating second intermediate data (d2) by converting the above-described first intermediate data (d1) by using the above-described disturbance information (R); generating third intermediate data (d3) from the above-described second intermediate data (d2) by using Lu⁻¹; generating fourth intermediate data (d4) by converting the above-described third intermediate data (d3) by using the above-described disturbance information (R); and calculating the above-described message authentication code (C) from the above-described fourth intermediate data (d4) through encryption.

In this configuration, for example, in the authentication code calculating unit and the process in the unit, a first (first type) addition by an exclusive-OR or an arithmetic addition, an encryption (block encryption), a second (second type) addition by an exclusive-OR or an arithmetic addition, and a third (third type) addition by an exclusive-OR or an arithmetic addition are provided for each of the conversion messages (M′) by the message blocks (B). In this configuration, a first addition of the conversion message (M′) by the first message block and γ₁L is calculated, the calculated output is encrypted, the first process result (second intermediate data: d2) is obtained by the second addition of the encrypted output (first intermediate data: d1) and the disturbance information (R). Then, a first addition of the conversion message (M′) by the second message block and γ₂L is calculated, the calculated output is encrypted, and the second process result (d2) is obtained by the second addition of the encrypted output (d1) and the first process result (d2). Thereafter, through the chain processing in the same manner, a first addition of the conversion message (M′) by the (m−1)-th message block and γₘ₋₁L is calculated, the calculated result is encrypted, and an (m−1)-th process result (d2) is obtained by a second addition of the encrypted output (d1) and the (m−2)-th process result (d2). Then, an addition of the conversion message (M′) by the m-th message block, the (m−1)-th process result (d2), and Lu⁻¹ is calculated to obtain an output (third intermediate data: d3). Subsequently, an output (fourth intermediate data: d4) obtained by an addition of the obtained output (d3) and the same disturbance information (R) as that of the above-described first process is encrypted to obtain an m-th process result as a message authentication code (T).

(2) A device (message authentication code verification device) according to the present invention performs a process (message authentication code verification process or message authentication process) of verifying the authenticity of a message (M) based on input of the message (data subjected to message authentication: M) and a first message authentication code (C1: before verification). The device also performs the process (message authentication code generating process) of generating a second message authentication code (C2: for use in verification) from the message (M) and a temporary use numerical value (N) and the process of comparing the above-described first message authentication code (C1) with the above-described second message authentication code (C2) to obtain the comparison result. In the process of generating the above-described message authentication code (C1, C2), the message authentication code generating device and the method thereof described in the above-described paragraph (1) are used.

(3) In a system (message authentication system) according to the present invention, a message and a first message authentication code (C1) from a message authentication code generating device are verified in a message authentication code verification device. Further, the message authentication code generating device described in the above-described paragraph (1) performs the process of generating the above-described first message authentication code (C1) and transmits the above-described message and the first message authentication code (C1) to the message authentication code verification device described in the above-described paragraph (2). In the message authentication code verification device described in the above-described paragraph (2), a process of generating a second message authentication code (C2) from the above-described message and a process of comparing the above-described first message authentication code (C1) with the above-described second message authentication code (C2) to obtain the comparison result are performed.

The effects obtained by typical aspects of the present invention will be briefly described below. According to the present invention, a message authentication technology capable of securing against side channel attack can be provided.

These and other benefits are described throughout the present specification. A further understanding of the nature and advantages of the invention may be realized by reference to the remaining portions of the specification and the attached drawings.

### BRIEF DESCRIPTIONS OF THE DRAWINGS

FIG. 1 is a diagram showing a configuration of a message authentication system according to the first to third embodiments of the present invention;

FIG. 2 is a diagram showing a configuration of a message authentication code processing unit according to the first to third embodiments of the present invention;

FIG. 3 is a sequence diagram illustrating reception and delivery of information in a message authentication code generating process according to the first to third embodiments of the present invention;

FIG. 4 is a flowchart illustrating the outline of the message authentication code generating process and a method for the same according to the first to third embodiments of the present invention;

FIG. 5 is a diagram illustrating the message authentication code generating method and a block configuration and process thereof according to the first embodiment of the present invention;

FIG. 6 is a flowchart illustrating the details of the message authentication code generating process and the method for the same according to the first embodiment of the present invention;

FIG. 7 is a diagram illustrating the message authentication code generating method and a block configuration and process thereof according to the second embodiment of the present invention;

FIG. 8 is a flowchart illustrating the details of the message authentication code generating process and the method for the same according to the second embodiment of the present invention;

FIG. 9 is a diagram illustrating the message authentication code generating method and a block configuration and process thereof according to the third embodiment of the present invention; and

FIG. 10 is a flowchart illustrating the details of the message authentication code generating process and the method for the same according to the third embodiment of the present invention.

### DETAILED DESCRIPTION OF EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

### First Embodiment

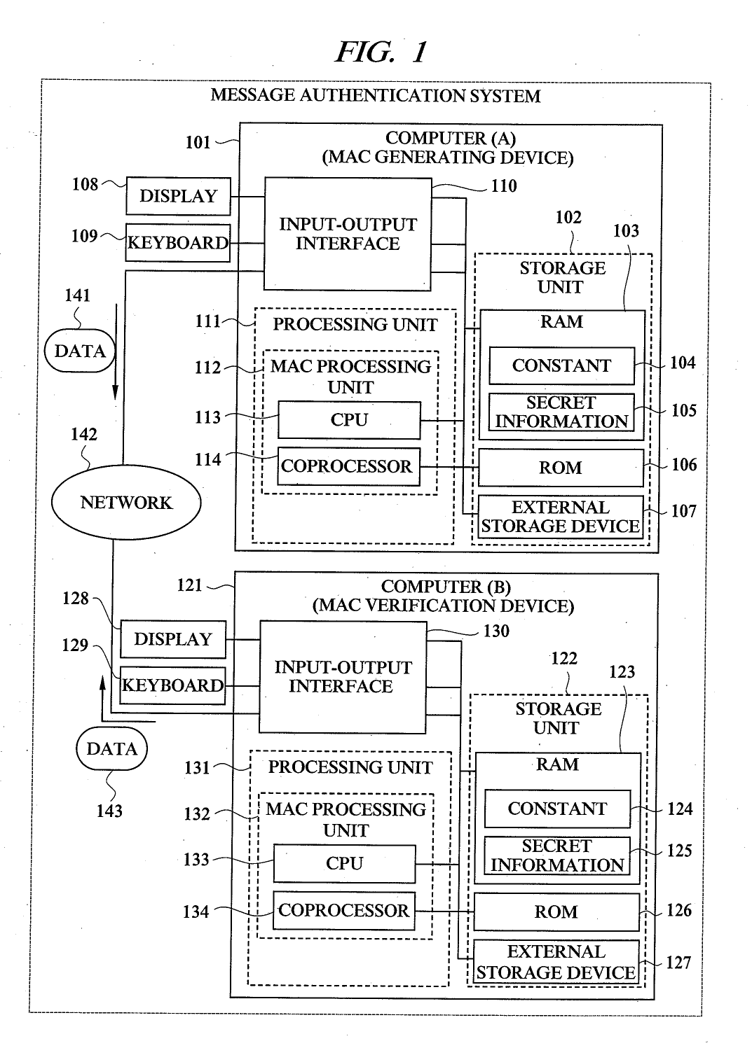

FIG. 1 to FIG. 6 show a configuration according to a first embodiment of the present invention. FIG. 1 shows the configuration of a message authentication system of the first embodiment including a message authentication code generating device and a message authentication code verification device, to which a message authentication code calculating method according to the present invention is applied.

<System Configuration>

FIG. 1 shows a system configuration in which a computer (A) 101 which is the message authentication code (MAC) generating device and a computer (B) 121 which is the message authentication code (MAC) verification device are connected to each other through a network 142. The computer (A) 101 is a MAC processing device provided with a MAC processing unit 112, and the computer (B) 121 is a MAC processing device provided with a MAC processing unit 132. More particularly, the computer (A) 101 is a MAC generating device provided with a function to generate a MAC, and the computer (B) 121 is a MAC verification device provided with a function to verify a MAC. A principal feature of the computer (A) 101 lies in the MAC processing unit 112, and that of the computer (B) 121 lies in the MAC processing unit 132, but both the computers may have other process functions related to security process and the like. For example, the MAC processing units 112 and 132 may be provided as a part of an encryption processing module. The computer (A) 101 and the computer (B) 121 are devices which are associated with each other and configure the whole message authentication system, and they have a common part (especially, MAC generating function).

First, the outline of the message authentication process in this system will be described below. The computer (A) 101 and the computer (B) 121 in the message authentication system shown in FIG. 1 secretly share a key (K) used for encryption process in advance.

The computer (A) 101 generates a message authentication code (first MAC: C1) for a message (M) by using the above-described key (K). The computer (A) 101 transmits the above-described message (M) and the above-described generated message authentication code (C1) as data 141 to the computer (B) 121 through the network 142.

For the message (M) and the message authentication code (C1) received as the data 141, the computer (B) 121 performs process to verify the authenticity of the message (M) by using the above-described shared key (K). In the verification of the authenticity of the message (M), a message authentication code (second MAC: C2) for the above-described message (M) is regenerated by using the above-described key (K), and the regenerated message authentication code (C2) and the received message authentication code (C1) are compared, and then, the verification result is determined based on whether the compared authentication codes match with each other. More specifically, when they match with each other, it is determined that the authenticity of the message (M) is maintained, and when they do not match with each other, it is determined that the authenticity of the message (M) is not maintained. It is needless to say that there is no guarantee that the computer (B) 121 and the computer (A) 101 generate data with the same contents at the time of regeneration of the above-described message authentication code (C2) because it is before the verification. For example, there is a possibility that the received message authentication code (C1) is forged data. The computer (B) 121 returns verification results and the like as data 143 to the computer (A) 101.

The message (M) and the message authentication code (C) are transmitted and the key (K) is not transmitted to the network 142. Since the key (K) is used for generating the message authentication code (C), only a computer holding the key (K) can generate the message authentication code (C). When the message authentication code (C2) regenerated in the above-described computer (B) 121 and the received message authentication code (C1) match with each other, it indicates that the received message authentication code (C1) is generated by a computer (that is, the computer (A) 101) holding the same key (K). In other words, it indicates that neither the message (M) nor the message authentication code (C) are forged when the data 141 is transmitted through the network 142, that is, the authenticity of the message (M) is verified.

<Device Configuration>

Next, the device configuration and others will be described. The computer (A) 101 and the computer (B) 121 may have a form of, for example, an IC card, an IC chip installed therein, or a personal computer (PC). The computer (B) 121 is provided with a MAC verification (comparison) function in addition to the MAC generation function similar to that of the computer (A) 101.

The computer (A) 101 includes, for example, arithmetic devices (included in a processing unit 111) such as a central processing unit (CPU) 113 and a coprocessor (processing device for numerical calculation) 114, storage devices such as a RAM 103, a ROM 106, and an external storage device 107, and an input-output interface 110 for data transmission with the outside of the computer (A) 101. A display (display device) 108 and a keyboard (input device) 109 through which a user operates the computer (A) 101, a read-write device for a detachable and portable storage medium, and others are connected to the computer (A) 101. Moreover, the computer (A) 101 is connected to the network 142 through the input-output interface 110.

Furthermore, in the computer (A) 101, a storage unit 102 is realized by using the above-described storage devices, and the message authentication code (MAC) processing unit 112 which is a part of the processing unit 111 is realized by executing the programs stored in the storage unit 102 by the above-described arithmetic devices. The MAC processing unit 112 generates the message authentication code (C1) for the inputted message (M). The processing unit 111 performs process related to the message authentication and the like by using the MAC processing unit 112. In the storage unit 102, constants 104 (for example, parameters such as initial values and bit lengths), secret information 105 (for example, key (K)), and the like are securely stored in, for example, the RAM 103.

The computer (B) 121 has a configuration similar to that of the computer (A) 101, and the difference therebetween mainly lies in a processing unit 131. In the computer (B) 121, a storage unit 122 is realized by using storage devices such as a RAM 123, a ROM 126, and an external storage device 127, and the MAC processing unit 132 which is a part of the processing unit 131 is realized by executing programs stored in the storage unit 122 by arithmetic devices such as a CPU 133 and a coprocessor 134. The MAC processing unit 132 verifies the authenticity of the message (M) by regenerating the message authentication code (C2) for the received message (M) and the message authentication code (C1) and by executing comparison between the message authentication codes (C1) and (C2). The processing unit 131 performs process related to message authentication and the like by using the MAC processing unit 132. The storage unit 122 securely stores constants 124, secret information 125 (for example, key (K)), and the like in, for example, the RAM 123.

Note that the computer (A) 101 and the computer (B) 121 in each embodiment can have the following configuration. In other words, programs and data in the computer (A) 101 and the computer (B) 121 may be stored in the storage units thereof (102 and 122) in advance or may be introduced from other devices into the above-described storage units (102 and 122) when required through a medium which can be Used by the computer (A) 101 and the computer (B) 121 and the input-output interfaces (110 and 130). Furthermore, programs and data in the computer (A) 101 and the computer (B) 121 may be introduced into the above-described storage units thereof (102 and 122) when required through a medium which can be used by other computers connected through the input-output interfaces (110 and 130) or the corresponding computers. The above-described medium which can be used by computers means, for example, a storage medium which may be detached or attached to the computers or a communication medium (network, carrier waves and digital signals, which are propagated through the network, or the like).

Note that, with respect to the key (K) secretly shared by the computer (A) 101 and the computer (B) 121, data for the key (K) may be inputted through the input-output interfaces (110 and 130) into the computer (A) 101 and the computer (B) 121. Alternatively, the key (K) may be shared by inputting the data in which the key (K) is encrypted and by decrypting the encrypted data in the computer (A) 101 and the computer (B) 121. Furthermore, the key (K) may be shared by using a technology for the public key cipher. In this case, for example, information about a public key is transmitted to a computer on the other side through the network 142, and a new key is derived based on the received information about a public key of the other computer by using own secret information.

<MAC Generating Process>

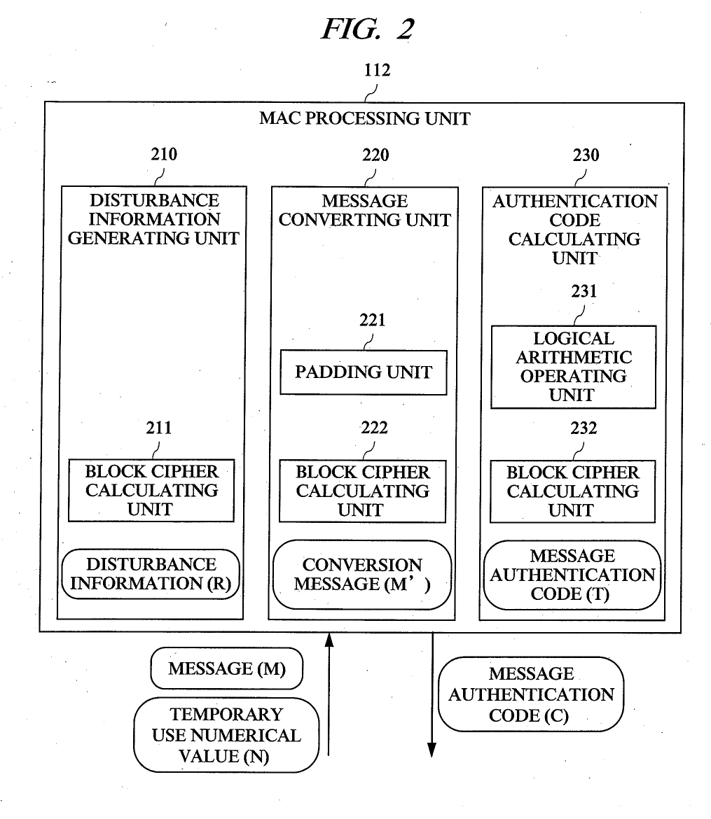

Next, MAC generating process performed by the MAC processing unit 112 in the computer (A) 101 of the message authentication system shown in FIG. 1 will be described with reference to FIG. 2 to FIG. 4. The MAC processing unit 112 having a functional block configuration shown in FIG. 2 is used in the first embodiment.

In FIG. 2, the MAC processing unit 112 includes a disturbance information generating unit 210, a message converting unit 220, and an authentication code calculating unit 230. The disturbance information generating unit 210 has a block cipher calculating unit 211. The message converting unit 220 has a padding unit 221 and a block cipher calculating unit 222. The authentication code calculating unit 230 has a logical arithmetic operating unit 231 and a block cipher calculating unit 232.

A message (M) and a temporary use numerical value (N) are inputted into the MAC processing unit 112, and a MAC authentication code (C) generated by the MAC generating process is outputted from the MAC processing unit 112. The disturbance information generating unit 210 generates disturbance information (R) based on the temporary use numerical value (N). The message converting unit 220 generates conversion messages (M′) based on the message (M). The authentication code calculating unit 230 calculates the message authentication code (C) based on the disturbance information (R) and the conversion messages (M′).

Each of the block cipher calculating units calculates block ciphers such as the data encryption standard (DES) and the advanced encryption standard (AES). The block cipher is represented by a symbol E. The block cipher E has two inputs such as a key K with a predetermined bit length (key length) and a message M₀ with a predetermined bit length (block length), and it outputs an encryption result E_{K} (M₀) of the message M₀ using the key K. The key length may be equal to the block length. Moreover, when it is not necessary to explicitly express the key K, the encrypted result is denoted as E(M₀) without expressing the key K. Although the block cipher calculating unit is included in each of the disturbance information generating unit 210, the message converting unit 220 and the authentication code calculating unit 230 in this embodiment, these block cipher calculating units (211, 222, and 232) may be integrated into one unit and may be accessed from each of the disturbance information generating unit 210, the message converting unit 220, and the authentication code calculating unit 230. The configuration described above can reduce the size of the circuit and the number of the program codes.

The padding unit 221 adds an appropriate binary string to a last message block (B) obtained when the inputted message (M) is divided for each block length to generate message blocks (B), thereby matching the bit length with the block length (padding process). The logical arithmetic operating unit 231 performs a logical operation and an arithmetic operation such as an exclusive-OR (XOR) and an arithmetic addition.

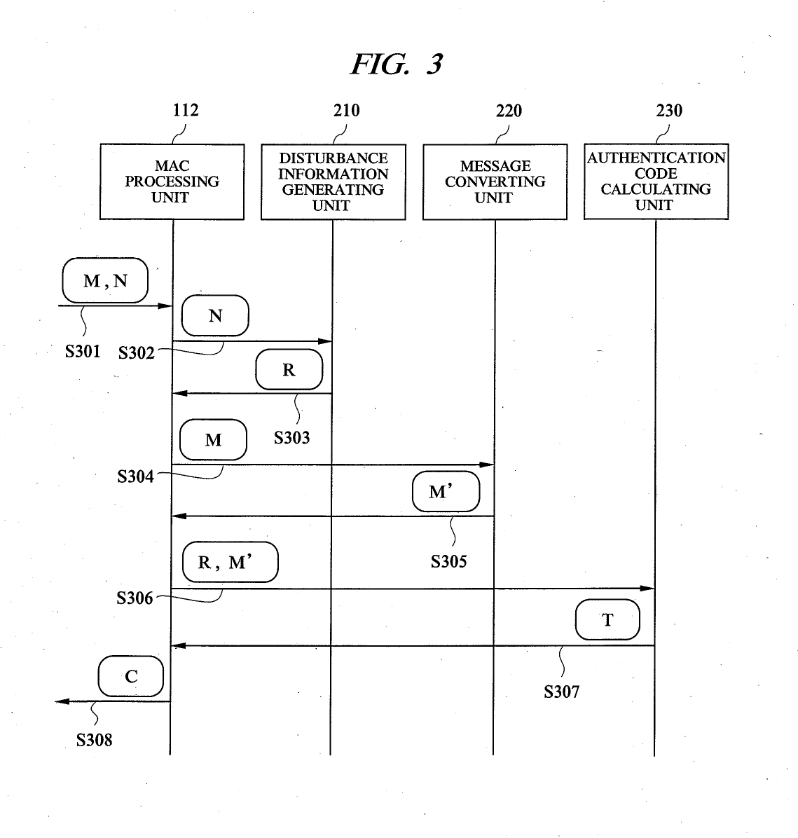

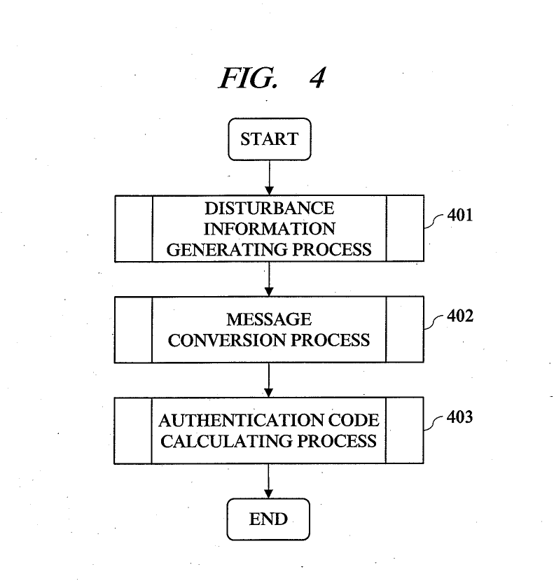

FIG. 3 illustrates the transmission of information during MAC generating process in the MAC processing unit 112 of the computer (A) 101 according to the MAC generating method. FIG. 4 illustrates the outline of the MAC generating process in the MAC processing unit 112. S denotes a process step.

In FIG. 3 and FIG. 4, the MAC processing unit 112 first receives the message (M) and the temporary use numerical value (N) as inputs (S301). Then, the MAC processing unit 112 sends the temporary use numerical value (N) to the disturbance information generating unit 210 (S302). Subsequently, the disturbance information generating unit 210 performs disturbance information generating process (401) in which the disturbance information (R) is generated by using the temporary use numerical value (N). Then, the disturbance information generating unit 210 sends the generated disturbance information (R) to the MAC processing unit 112 (S303).

Next, the MAC processing unit 112 sends the message (M) to the message converting unit 220 (S304). Subsequently, the message converting unit 220 performs the message conversion process (402) in which the conversion messages (M′) are obtained by converting the message (M) (including conversion to the message blocks (B)). Then, the message converting unit 220 sends the obtained conversion messages (M′) to the MAC processing unit 112 (S305).

Next, the MAC processing unit 112 sends the disturbance information (R) and the conversion messages (M′) to the authentication code calculating unit 230 (S306). Subsequently, the authentication code calculating unit 230 performs authentication code calculating process (403) in which a message authentication code (T) is calculated by using the disturbance information (R) and the conversion messages (M′). Then, the authentication code calculating unit 230 sends the message authentication code (T) obtained by the calculation to the MAC processing unit 112 (S307).

Next, the MAC processing unit 112 determines the message authentication code (C) (especially, first MAC: C1) for the message (M) based on the received message authentication code (T), and then outputs the message authentication code (C) (S308).

Note that, with respect to the above-described temporary use numerical value (N), the same temporary use numerical value (N) is used for generating the message authentication code (C) only once (ad hoc basis). More specifically, different values are used as the temporary use numerical values (N) for different messages (M). As an example of the temporary use numerical value (N), a counter or random numbers may be used. For example, a counter or a random number generating unit are provided in the computers (A) 101 and the computer (B) 121, and an increment value in the counter or a random value generated in the random number generating unit is used as the temporary use numerical value (N).

<First Configuration>

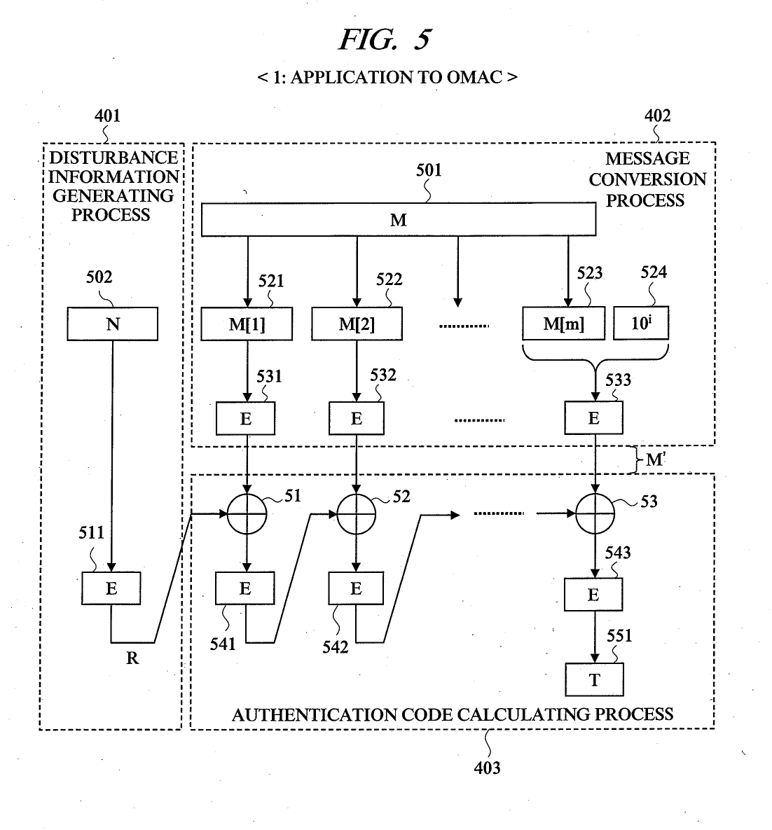

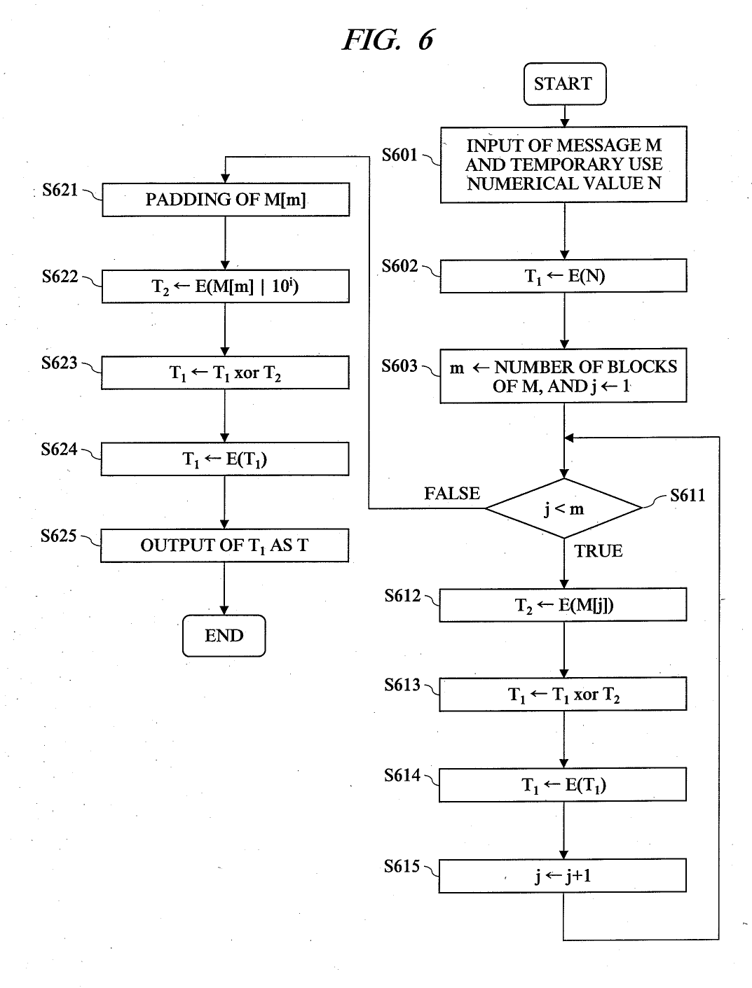

In the first embodiment, an example (first configuration of the MAC processing unit 112) in which the message authentication code is formed based on the method of OMAC described in the above-described document 1 will be described. The process performed in the disturbance information generating unit 210, the message converting unit 220, and the authentication code calculating unit 230 included in the MAC processing unit 112 will be described in detail with reference to FIG. 5 and FIG. 6. FIG. 5 illustrates the MAC generating method corresponding to the MAC processing unit 112 in FIG. 2 and a block configuration and process thereof. FIG. 6 illustrates the details of the MAC generating process. The block configuration shown in FIG. 5 shows relations among the disturbance information generating process (401) performed by the disturbance information generating unit 210, the message conversion process (402) performed by the message converting unit 220, and the authentication code calculating process (403) performed by the authentication code calculating unit 230, and the detailed process described below.

In FIG. 5, in the first configuration, disturbance information (R) is generated by block encryption E (511) of a temporary use numerical value N (502) in the disturbance information generating unit 210 and the process thereof (401). In the message converting unit 220 and the message conversion process thereof (402), message blocks (B): M[1] (521) to M[m] (523) are obtained by dividing the message M (501) into blocks with predetermined block lengths. A value 10ⁱ (524) is the value for the padding process. Moreover, the conversion messages (M′) are obtained by block encryption E (531 to 533) of the above-described message blocks (B). In the authentication code calculating unit 230 and the process thereof (403), the exclusive-OR (51 to 53) and the block encryption E (541 to 543) are provided for each of the conversion messages (M′) by the message blocks (B). In this configuration, the exclusive-OR (51) between the conversion message (M′) by the first message block (M[1]) and the disturbance information (R) is calculated, and a first process result is obtained by the block encryption E (541) of the calculated output. Then, the exclusive-OR (52) between the conversion message (M′) by the second message block (M[2]) and the above-described first process result is calculated, and a second process result is obtained by the block encryption E (542) of the calculated output. Thereafter, through the chain processing in the same manner, the exclusive-OR (53) between the conversion message (M′) by the m-th message block (M[m]) and the (m−1)-th process result is calculated, and an m-th process result is obtained as a message authentication code (T) (551) by the block encryption E (543) of the calculated output.

In FIG. 5 and FIG. 6, the MAC processing unit 112 receives the message M and the temporary use numerical value N as inputs (S601). The disturbance information generating unit 210 calculates the encryption result E (N) by the block cipher E for the temporary use numerical value N by using the block cipher calculating unit 211, and the calculated result E (N) is stored in a variable T₁ as disturbance information (R) (S602).

The MAC processing unit 112 substitutes the number of blocks of the message M to m and 1 to a variable j (S603). The number of blocks (m) mentioned here represents the number of message blocks (B) obtained by dividing the message M into blocks with respective block lengths. The message M (501) is divided into the message blocks (B): M[1] to M[m] (521 to 523).

The MAC processing unit 112 determines (S611) whether j is smaller than m. When this condition is satisfied (TRUE), the process goes to S612. When this condition is not satisfied (FALSE), the process goes to S621.

When the condition is satisfied at S611, the message converting unit 220 calculates an encryption result E (M[j]) by the block cipher E for a message block M [j] at S612 by using the block cipher calculating unit 222, and the calculated result is stored in a variable T₂ as a part of the conversion messages (M′) (S612). Then, the authentication code calculating unit 230 calculates an exclusive-OR (T₁xorT₂) between the variable T₁ and the variable T₂ by using the logical arithmetic operating unit 231, and the calculated result is stored in the variable T₁ (S613). Subsequently, the authentication code calculating unit 230 calculates an encryption result E (T₁) by the block cipher E for the variable T₁ by using the block cipher calculating unit 232, and the calculated result is stored in the variable T₁ (S614). Then, the MAC processing unit 112 substitutes (j+1) into the variable j, and the process returns to S611 (S615).

When the condition is not satisfied at S611, the message converting unit 220 performs padding of the message block M[m] (the last message block (B)) at S621 by using the padding unit 221 (S621). In this example, the padding value for the message block M[m] is assumed to be 10ⁱ=‘10 . . . 0’ (524). Note that the padding is not required when the bit length of the message block M[m] matches with the block length used in dividing. In this case, a new message block M[m+1] may be added as an (m+1)-th message block (B). When the (m+1)-th message block is to be added, the process at S612 to S615 is performed for the message block M[m], and the process at S621 and subsequent steps is performed for the (m+1)-th message block.

Then, the message converting unit 220 calculates an encryption result E (M[m]|10 . . . 0) by the block cipher E for the padded message block M[m]|10 . . . 0, which is the last message block (B), by using the block cipher calculating unit 222, and the calculated result is stored in the variable T₂ as a part of the conversion message (M′) (S622). Note that the expression “M[m]|10 . . . 0” represents that 10ⁱ=‘10 . . . 0’ (the first digit is 1 and all the i number of subsequent digits are 0) as one example of the padding (values) is added to just after the original data of the message block M[m] before padding. By the addition of such padding values, it becomes possible to perform the process of extracting the original data from the message block M [m].

Then, the authentication code calculating unit 230 calculates the exclusive-OR (T₁xorT₂) between the variable T₁ and the variable T₂ by using the logical arithmetic operating unit 231, and the calculated result is stored in the variable T₁ (S623). Subsequently, the authentication code calculating unit 230 calculates the encryption result E (T₁) by the block cipher E for the variable T₁ by using the block cipher calculating unit 232, and the calculated result is stored in the variable T₁ (S624) as a message authentication code (T) outputted by the authentication code calculating unit 230. Then, the MAC processing unit 112 cuts out the predetermined number of bits from the variable T₁ and then outputs the bits as a message authentication code (T₁ especially C1) (S625).

Alternatively, the above-described process may be varied as follows. That is, although the exclusive-OR (xor) has been operated at S612 and S623, arithmetic addition may be used instead of it. Moreover, the temporary use numerical value (N) which is an input into the disturbance information generating unit 210 may be generated in the disturbance information generating unit 210. In this case, the generated temporary use numerical value (N) is required to be outputted.

Further, keys (K) for the block cipher E used in the disturbance information generating unit 210, the message converting unit 220, and the authentication code calculating unit 230 may be different from one another. Furthermore, different keys may be used in each calculation for the block cipher E. However, it is a precondition that the same key is used in the corresponding calculations for the block cipher E at the time when the MAC (C1) is generated on the side of the computer (A) 101 and at the time when the MAC (C2) is regenerated at verification on the side of the computer (B) 121.

Moreover, although the case where the message converting unit 220 performs message conversion has been described above, no message conversion may be required in some cases. In such a case, the security of message authentication may be lowered, but the process speed can be increased because the number of encryption processes by the block cipher E can be reduced.

Also, the key (K) which the computer (A) 101 and the computer (B) 121 secretly share can be directly used as a key used for the block cipher E. Alternatively, a value derived from the key (K) may be used as a new key. For example, E_{K}(0) may be used as a key.

Moreover, padding of the m-th message block M[m] is performed at S621, and 10ⁱ=10 . . . 0’ (524) is added for the padding. However, instead of the addition of 10ⁱ=‘10 . . . 0’ (524), ‘01 . . . 1’ or other values such as a numerical value showing the number (m) of blocks may be added.

Moreover, the description above is made based on the case where the message conversion process (402) and the authentication code calculating process (403) are separated, and the separated processes are alternately performed. More specifically, the process in this example is performed in the order of the conversion process (521, 531) of the first message block M[1], the calculating process (51, 541) of the block M[1], the conversion process (522, 532) of the second message block M[2], and the calculating process (52, 542) of the block M[2], . . . . However, the authentication code calculating process (403) of all the conversion messages (M′) may be started after completing the message conversion process (402) of all the message blocks M[1] to M[m]. Further, the authentication code calculating process (403) has to be performed after the disturbance information generating process (401) and the message conversion process (402) are completed. However, the disturbance information generating process (401) and the message conversion process (402) may be performed in an arbitrary order. For example, the disturbance information generation process (401) may be performed after the message conversion process (402).

Moreover, in the message conversion process (402), the conversion process, that is, the calculation of the message blocks (B): M[1] to M[m] may be speeded up by parallel computing. For example, encryption calculation of E (M[1]) and that of E (M[2]) can be performed in parallel. Further, the calculating order of the message blocks (B) can be changed. For example, the encryption calculation of E (M[1]) can be performed after the encryption calculation of E (M[2]).

Also, the configuration of this example is based on the precondition that the whole of a series of the block ciphers E (conventional technology) of the MAC processing unit 112 is provided with resistance to side channel attack, but the configuration where measures against the side channel attack are individually provided for calculation of each block cipher E is also possible. The above configuration further increases the security at the generation of the message authentication code (C).

Although the description above is made with using OMAC as an example, it is also possible to use other message authentication code of the cipher-block chaining (CBC) mode as an example. CBC is one of methods (modes) for use in a block cipher (CB). OMAC is one of MACs using the CBC mode.

As described above, according to the first embodiment, input values into the exclusive-OR (51 to 53) during the process are concealed and disturbed by using the disturbance information (R), and the side channel attack is invalidated. The detail will be described below.

In the side channel attack mentioned here, inputs of fixed values and known values are required when the secret information is specified. According to the above-described document 4, the message authentication becomes vulnerable against the side channel attack when the following exclusive-OR exists in the message authentication, that is, in the case where one of two inputs of the exclusive-OR is a fixed value and a secret value for an attacker and the other is a known value for the attacker and may be changed by the attacker. Considering the case mentioned above, it can be said that the conventional authentication code calculating process corresponding to the authentication code calculating process 403 is not resistant to the side channel attack as a whole.

On the other hand, in the first embodiment, regarding the exclusive-OR 51, since the disturbance information (R) which is one of the input values thereof is a value changed each time and is a secret value for an attacker, even when a conversion message (M′) which is the other input value thereof is a known value for the attacker, the output result of the exclusive-OR 51 cannot be expected. This is true of other exclusive-OR (52 and 53). Accordingly, in the configuration according to the first embodiment where the input values to the exclusive-OR (51 to 53) in the authentication code calculating process 403 are concealed and disturbed, the side channel attack can be invalidated.

As described above, the message authentication method and the method and process for generating MAC according to the first embodiment can achieve the excellent resistance to the side channel attack.

### Second Embodiment

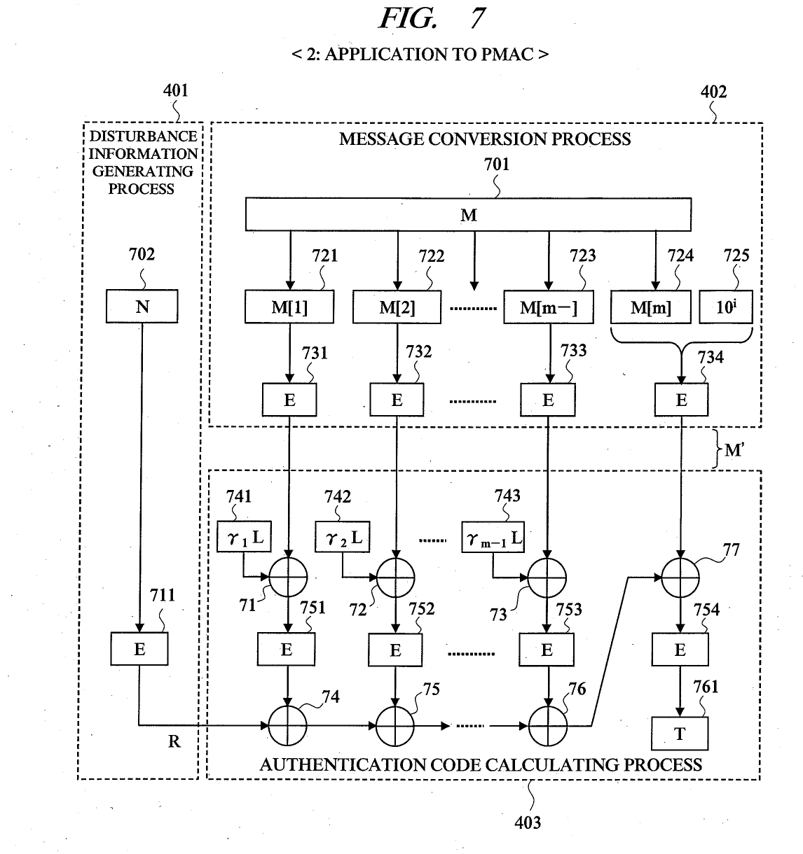

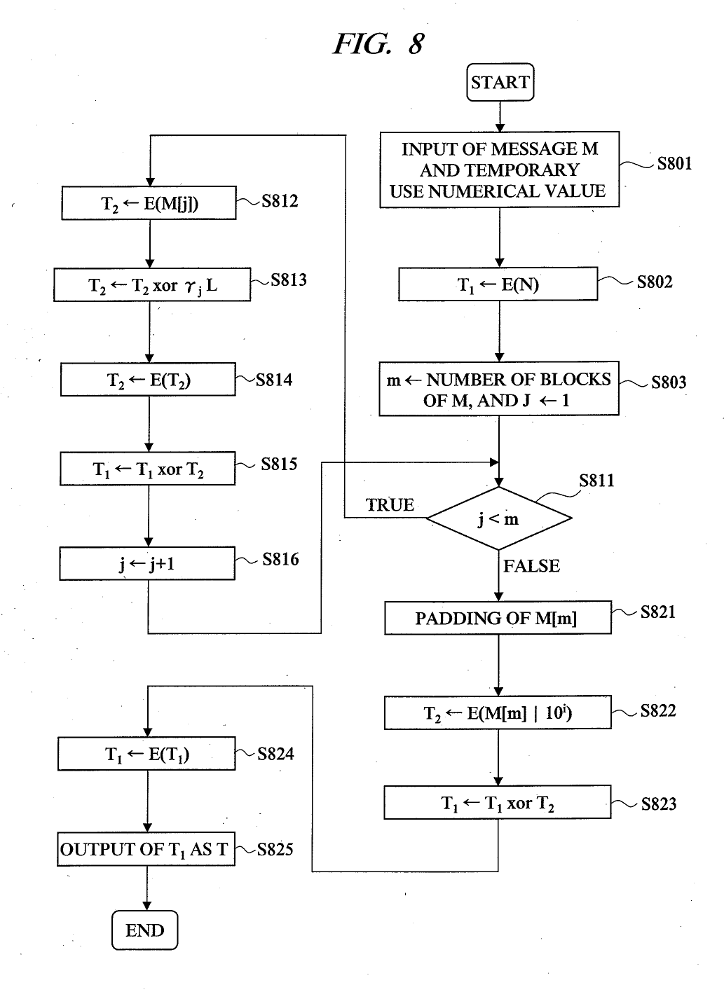

Then, a second embodiment according to the present invention will be described with reference to FIG. 7 and FIG. 8. In the second embodiment, an example (second configuration for the MAC processing unit 112) in which a message authentication code is formed based on the method of PMAC described in the above-described document 2 will be described. The second embodiment has the same basic configuration as that of the first embodiment, but the difference therebetween mainly lies in the authentication code calculating process (403).

<Second Configuration>

The process in the disturbance information generating unit 210, the message converting unit 220, and the authentication code calculating unit 230 in the MAC processing unit 112 will be described in detail with reference to FIG. 7 and FIG. 8. The block configuration shown in FIG. 7 shows relations among the disturbance information generating process (401) performed by the disturbance information generating unit 210, the message conversion process (402) performed by the message converting unit 220, and the authentication code calculating process (403) performed by the authentication code calculating unit 230, and the detailed process described below.

In FIG. 7, in the second configuration, the disturbance information (R) is generated by block encryption E (711) of a temporary use numerical value N (702) in the disturbance information generating unit 210 and the process thereof (401). In the message converting unit 220 and the message conversion process thereof (402), message blocks (B): M[1] (721) to M[m] (723) are obtained by dividing the message M (701) into blocks with predetermined block lengths. A value 10ⁱ (724) is the value for use in the padding process. Moreover, the conversion messages (M′) are obtained by block encryption E (731 to 733) of the above-described message blocks (B). In the authentication code calculating unit 230 and the process thereof (403), the first exclusive-OR (71 to 73 and 77), the block encryption E (741 to 743), and the second exclusive-OR (74 to 76) are provided for each of the conversion messages (M′) by the message blocks (B). In this configuration, the exclusive-OR (71) between the conversion message (M′) by the first message block (M[1]) and γ₁L (741) is calculated, block encryption E (751) of the calculated output is performed, and a first process result is obtained by the exclusive-OR (74) between the output of the block encryption E (751) and the disturbance information (R). Then, the exclusive-OR (72) between the conversion message (M′) by the second message block (M[2]) and γ₂L (742) is calculated, block encryption E (752) of the calculated output is performed, and a second process result is obtained by the exclusive-OR (75) between the output of the block encryption E (752) and the first process result. Thereafter, through the chain processing in the same manner, the exclusive-OR (73) between the conversion message (M′) by the (m−1)-th message block (M[m−1]) and γₘ₋₁L (743) is calculated, block encryption E (753) of the calculated output is performed, and an (m−1)-th process result is obtained by the exclusive-OR (76) between the output of the block encryption E (753) and the (m−2)-th process result. Finally, an exclusive-OR (77) between the conversion message (M′) by the m-th message block (M[m]) and the (m−1)-th process result is calculated, and an m-th process result is obtained as a message authentication code (T) (761) by block encryption (754) of the calculated output.

In FIG. 7 and FIG. 8, the MAC processing unit 112 receives the message M and the temporary use numerical value N as inputs (S801). Then, the disturbance information generating unit 210 calculates the encryption result E (N) by the block cipher E for the temporary use numerical value N by using the block cipher calculating unit 211, and the calculated result E (N) is stored in a variable T₁ as disturbance information (R) (S802). Next, the MAC processing unit 112 substitutes the number of blocks of the message M to m and 1 into a variable j (S803).

Then, the MAC processing unit 112 determines (S811) whether j is smaller than m. When the above condition is satisfied (TRUE), the process goes to S812. When the condition is not satisfied (FALSE), the process goes to S821.

When the condition is satisfied at S811, the message converting unit 220 calculates an encryption result E (M[j]) by the block cipher E for a message block M[j] at S812 by using the block cipher calculating unit 222, and the calculated result is stored in a variable T₂ as a part of the conversion messages (M′) (S812).

Then, the authentication code calculating unit 230 calculates an exclusive-OR (T₂xorγⱼL) between the variable T₂ and the value γⱼL by using the logical arithmetic operating unit 231, and the calculated result is stored in the variable T₂ (S813). L is a numerical value given by an encryption result L=E_{K}(0) of the block cipher E for 0. γⱼ is called a Gray code, and γᵢ and γᵢ₊₁ for each i are different from each other by only one bit. More specifically, it can be obtained by defining γᵢ₊₁=γᵢ xor((0 . . . 01)<<ntz(i)) when i=0, 1, . . . , under the condition of γ₀=0. Here, “a<<b” represents that a is shifted by b bits to the left, and ntz(i) is a rightmost bit position at which a bit value becomes 1 when a numerical value i is expressed in a binary representation. For example, ntz(7)=0 and ntz(8)=3. Moreover, γⱼL is a multiplication result between γⱼ and L in a binary form.

Then, the authentication code calculating unit 230 calculates a block encryption result E (T₂) by the block cipher E for a variable T₂ by using the block cipher calculating unit 232, and the calculated result is stored in the variable T₂ (S814). Subsequently, the authentication code calculating unit 230 calculates an exclusive-OR (T₁xorT₂) between the variable T₁ and the variable T₂ by using the logical arithmetic operating unit 231, and the calculated result is stored in the variable T₁ (S815). Then, the MAC processing unit 112 substitutes (j+1) to the variable j, and the process returns to S811 (S816).

When the condition is not satisfied at S811, the message converting unit 220 performs padding of the message block M[m] at S821 by using the padding unit 221. Note that padding is not required when the bit length of the message block M[m] matches with the block length. Moreover, a new message block M[m+1] may be added as the (m+1)-th message block (B). When the (m+1)-th message block M[m+1] is added, the process at S812 to S816 is performed for the message block M[m], and the process at S821 and subsequent steps is performed for the (m+1)-th message block M[m+1].

Then, the message converting unit 220 calculates an encryption result E (M[m]|10 . . . 0) by the block cipher E for the padded message block M[m]|10 . . . 0 by using the block cipher calculating unit 222, and the calculated result is stored in a variable T₂ as a part of the conversion messages (M′) (S822). Subsequently, the authentication code calculating unit 230 calculates an exclusive-OR (T₁xorT₂) between the variable T₁ and the variable T₂ by using the logical arithmetic operating unit 231, and the calculated result is stored in the variable T₁ (S823). Then, the authentication code calculating unit 230 calculates the encryption result E (T₁) by the block cipher E for the variable T₁ by using the block cipher calculating unit 232, and the calculated result is stored in the variable T₁ (S824) as a message authentication code (T) outputted by the authentication code calculating unit 230. Subsequently, the MAC processing unit 112 cuts out the predetermined number of bits from the variable T₁, and then outputs the bits as a message authentication code (T, especially C1) (S825).

Note that the above-described process can be varied in the same manner as that described in the first embodiment.

As described above, according to the second embodiment, the input values to the exclusive-OR (74 to 77) during the process are concealed and disturbed, and the side channel attack can be invalidated. Similar to the first embodiment, the message authentication method and the method and process for generating MAC according to the second embodiment can achieve the excellent resistance to the side channel attack.

### Third Embodiment

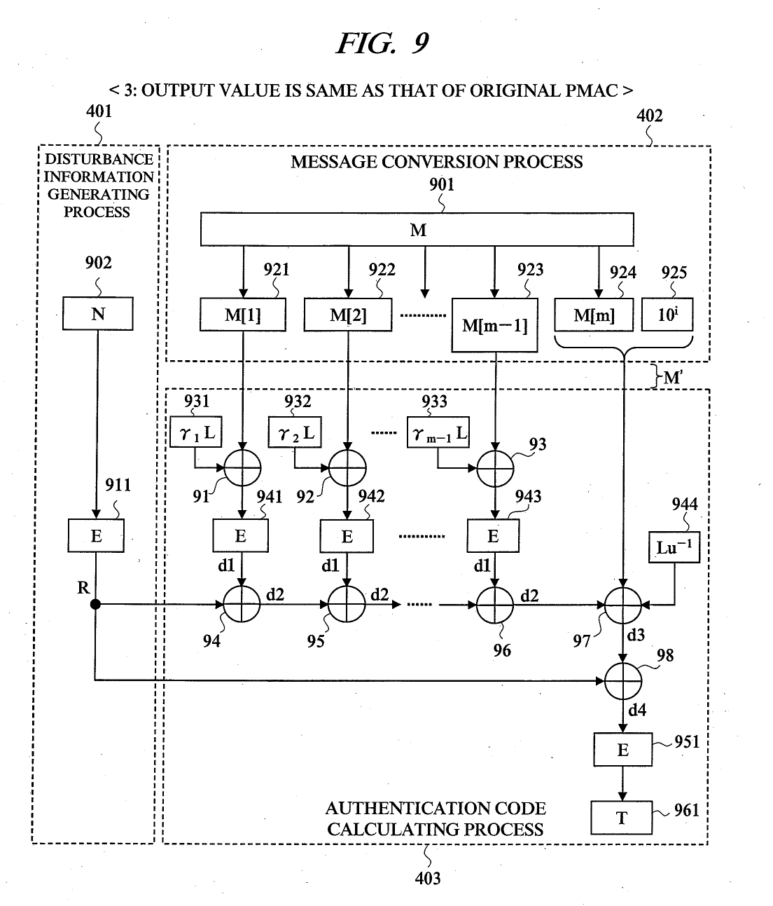

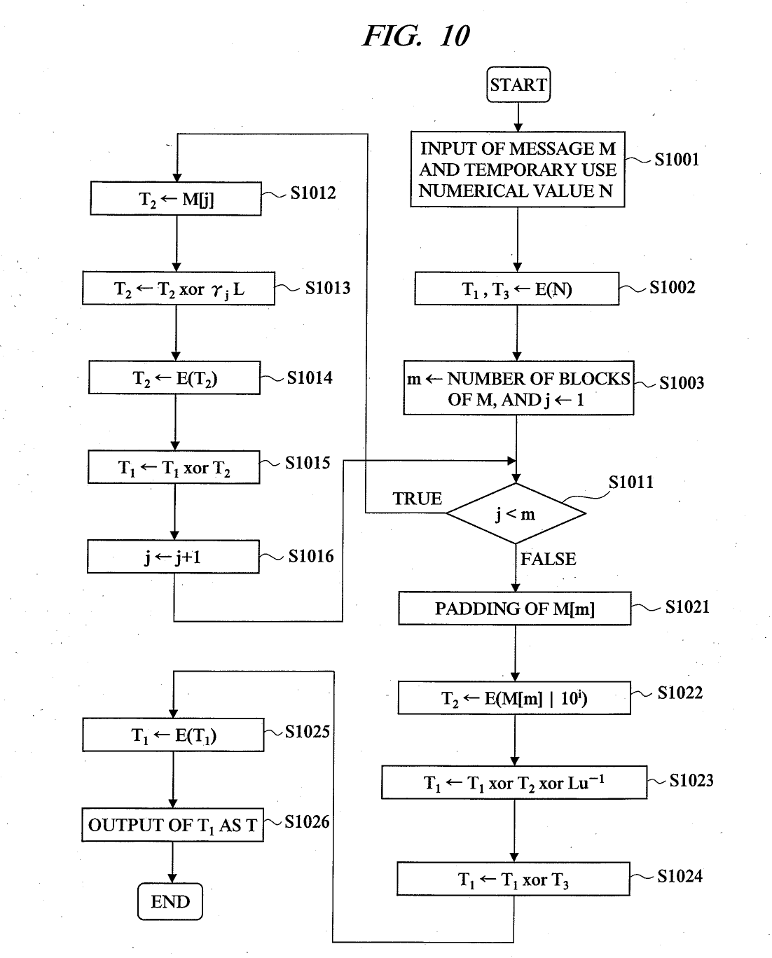

Then, a third embodiment according to the present invention will be described with reference to FIG. 9 and FIG. 10. In the third embodiment, an example (third configuration for the MAC processing unit 112) in which a message authentication code is formed based on the method of PMAC described in the above-described document 2 and a message authentication code with the same value as that of the message authentication code outputted in accordance with the original PMAC (already established technique) is outputted will be described. The third embodiment has a basic configuration common to those of the first and second embodiments, but a main difference lies in the message conversion process (402) and the authentication code calculating process (403). A message converting unit 220 in the third embodiment is not provided with a block cipher calculating unit 222. By this configuration, the size of the circuit and the number of the program codes can be reduced. In the above-described second embodiment, for the PMAC, even when the input value (M) is the same, output values (T) differ. In the third embodiment, for the PMAC of the present configuration, if an input value (M) is the same as the input value of the original PMAC, output values (T) therefrom become the same. The same output is advantageous in the interchangeability and the like.

<Third Configuration>

The process in a disturbance information generating unit 210, a message converting unit 220, and an authentication code calculating unit 230 in a MAC processing unit 112 will be described in detail with reference to FIG. 9 and FIG. 10. The block configuration shown in FIG. 9 shows relations among the disturbance information generating process (401) performed by the disturbance information generating unit 210, the message conversion process (402) performed by the message converting unit 220, and the authentication code calculating process (403) performed by the authentication code calculating unit 230, and detailed process shown below.

In FIG. 9, in the third configuration, in the authentication code calculating unit 230 and the process thereof (403), first (first type) exclusive-OR (91 to 93), block encryption E (941 to 943), second (second type) exclusive-OR (94 to 97), and third (third type) exclusive-OR (98) are provided for each of the conversion messages (M′) by the message blocks (B). The description will be made by using intermediate data (d1 to d4) during the various processes in the authentication code calculating process (403). In this configuration, the first exclusive-OR (91) between the conversion message (M′) by the first message block and γ₁L (931) is calculated, block encryption E (941) of the calculated output is performed, and a first process result (the second intermediate data: d2) is obtained by the second exclusive-OR (94) between the output of the block encryption E (941) (the first intermediate data: d1) and the disturbance information (R). Then, the first exclusive-OR (92) between the conversion message (M′) by the second message block and γ₂L (932) is calculated, the block encryption E (942) of the calculated output is performed, and a second process result (d2) is obtained by the second exclusive-OR (95) between the output of the block encryption E (942) (d1) and the first process result (d2). Thereafter, through the chain processing in the same manner, a first addition of the conversion message (M′) by the (m−1)-th message block and γₘ₋₁L is calculated, the encryption of the calculated output is performed, and an (m−1)-th process result (d2) is obtained by the second addition of the output (d1) of the encryption and the (m−2)-th process result (d2). Then, an output (the third intermediate data: d3) is obtained by calculating the addition of the conversion message (M′) by the m-th message block, the (m−1)-th process result (d2), and Lu⁻¹. Subsequently, an output (the fourth intermediate data: d4) is obtained by the addition of the obtained output (d3) and the same disturbance information (R) as that used in the above-described first process, and the m-th process result is obtained as a message authentication code (T) by the encryption of the output (d4).

In FIG. 9 and FIG. 10, the MAC processing unit 112 receives the message M and the temporary use numerical value N as inputs (S1001). Then, the disturbance information generating unit 210 calculates the encryption result E (N) by the block cipher E for the temporary use numerical value N by using the block cipher calculating unit 211, and the calculated result is stored in variables T₁ and T₃ as disturbance information (R) (S1002). Subsequently, the MAC processing unit 112 substitutes the number of blocks of the message M to m and 1 into a variable j (S1003).

Then, the MAC processing unit 112 determines (S1011) whether j is smaller than m. When this condition is satisfied (TRUE), the process goes to S1012. When this condition is not satisfied (FALSE), the process goes to S1021.

When the condition is satisfied at S1011, the message converting unit 220 stores the value of the message block M[j] in the variable T₂ as a part of the conversion messages (M′) at S1012 (S1012). Then, the authentication code calculating unit 230 calculates an exclusive-OR (T₂xorγⱼL) between the variable T₂ and the numerical value γⱼL by using the logical arithmetic operating unit 231, and the calculated result is stored in the variable T₂ (S1013).

Then, the authentication code calculating unit 230 calculates the encryption result E (T₂) by the block cipher E for the variable T₂ by using the block cipher calculating unit 232, and the calculated result is stored in the variable T₂ (S1014). Subsequently, the authentication code calculating unit 230 calculates the exclusive-OR (T₁xorT₂) between the variable T₁ and the variable T₂ by using the logical arithmetic operating unit 231, and the calculated result is stored in the variable T₁ (S1015). Then, the MAC processing unit 112 substitutes (j+1) to the variable j, and the process returns to S1011 (S1016).

When the condition is not satisfied at S1011, the message converting unit 220 performs padding of the message block M[m] at S1021 by using the padding unit 221 to obtain the padded result as a part of the conversion message (M′). Note that the padding is not required when the bit length of the message block M[m] matches with the block length.

Then, the authentication code calculating unit 230 calculates an encryption result E (M[m]|10 . . . 0) by the block cipher E for the padded message block M[m]|10 . . . 0 by using the block cipher calculating unit 232, and the calculated result is stored in the variable T₂ (S1022). Then, the authentication code calculating unit 230 calculates an exclusive-OR (T₁xorT₂xorLu⁻¹) between the variable T₁, the variable T₂, and the numeric value Lu⁻¹ (944) by using the logical arithmetic operating unit 231, and the calculated result is stored in the variable T₁ (S1023). However, the exclusive-OR with the numerical value Lu⁻¹ is performed when the bit length of the message block M[m] matches with the block length, that is, when padding is not required. When padding is not required, the exclusive-OR (T₁xorT₂) is calculated by using the logical arithmetic operating unit 231, and the calculated result is stored in the variable T₁. Moreover, u is a numerical value representing ‘0 . . . 010’, and u⁻¹ is an inverse element of u in the binary form. That is, u⁻¹ is a numerical value satisfying uu⁻¹=1 in a multiplication in the binary form. Lu⁻¹ is a multiplication result between L and u⁻¹ in the binary form.

Then, the authentication code calculating unit 230 calculates an exclusive-OR (T₁xorT₃) between the variable T₁ and the variable T₃ by using the logical arithmetic operating unit 231, and the calculated result is stored in the variable T₁ (S1024). Subsequently, the authentication code calculating unit 230 calculates an encryption result E (T₁) by the block cipher E for the variable T₁ by using the block cipher calculating unit 232, and the calculated result is stored in the variable T₁ as a message-authentication code (T) outputted by the authentication code calculating unit 230 (S1025). Then, the MAC processing unit 112 cuts out the predetermined number of bits from the variable T₁, and then outputs the bits as a message authentication code (T, especially C1) (S1026).

In the process through the exclusive-OR (94, 98) after the block encryption E in the authentication code calculating process (403), the disturbance information (R) added in the first exclusive-OR (94) at S1015 is canceled (removed) by the last exclusive-OR (94) at S1024. Accordingly, the value of the message authentication code (T) outputted in the third embodiment becomes equal to that of the message authentication code outputted in the original PMAC.

Note that the above-described process can be varied in the same manner as that of the first embodiment.

As described above, according to the third embodiment, the input values to the exclusive-OR (94 to 98) during the process are concealed and disturbed, and the side channel attack can be invalidated. Similar to the first and second embodiments, the message authentication method and the method and process for generating MAC according to the third embodiment can achieve the excellent resistance to the side channel attack, and are characterized in that the same message authentication code as that of the original PMAC is outputted.

In the foregoing, the invention made by the inventors of the present invention has been concretely described based on the embodiments. However, it is needless to say that the present invention is not limited to the foregoing embodiments and various modifications and alterations can be made within the scope of the present invention. For example, a coprocessor or specifically designed hardware may be used for the processes performed by the MAC processing unit, the disturbance information generating unit, the message converting unit, the authentication code calculating unit, the logical arithmetic operating unit, the block cipher calculating unit, and the padding unit in the above embodiments.

The present invention can be used for, for example, an information processing device using message authentication.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. A message authentication code generating device in which a message authentication code for a message is calculated from the message, comprising:
a disturbance information generating unit which performs a process of generating disturbance information by using a temporary use numerical value;
a message converting unit which performs a process of calculating conversion messages from the message; and
an authentication code calculating unit which performs a process of calculating the message authentication code from the disturbance information and the conversion messages.

2. The message authentication code generating device according to claim 1,
wherein the process of generating the disturbance information performed by the disturbance information generating unit includes a process step of encrypting the temporary use numerical value.

3. The message authentication code generating device according to claim 2,
wherein the process of calculating the conversion messages performed by the message converting unit includes a process step of dividing the message into message blocks and encrypting the message blocks.

4. The message authentication code generating device according to claim 3,
wherein the process of calculating the message authentication code performed by the message authentication code calculating unit is a process using OMAC.

5. The message authentication code generating device according to claim 3,
wherein the process of calculating the message authentication code performed by the message authentication code calculating unit is a process using PMAC.

6. The message authentication code generating device according to claim 2,
wherein the process of calculating the message authentication code performed by the authentication code calculating unit comprises process steps of:
generating first intermediate data from the conversion message;
converting the first intermediate data by using the disturbance information to generate second intermediate data;
generating third intermediate data from the second intermediate data;
converting the third intermediate data by using the disturbance information to generate fourth intermediate data; and
calculating the message authentication code from the fourth intermediate data.

7. The message authentication code generating device according to claim 4,
wherein the process of calculating the message authentication code performed by the authentication code calculating unit includes a chain processing of a process step in which an addition by exclusive-OR or arithmetic addition for acting the disturbance information and an encryption of the output result thereof are performed for each of the conversion messages by the message blocks.

8. The message authentication code generating device according to claim 5,
wherein the process of calculating the message authentication code performed by the authentication code calculating unit includes a chain processing of a process step in which a first addition by exclusive-OR or arithmetic addition for acting multiplication results (γⱼL) in a binary form between the Gray code and encryption results for 0, an encryption of the output result thereof, and a second addition by exclusive-OR or arithmetic addition for acting the disturbance information are performed for each of the conversion messages by the message blocks.

9. A message authentication code verification device for verifying authenticity of a message by using the message and a first message authentication code used for verifying the authenticity of the message, executing process steps of:
generating a second message authentication code from the message and a temporary use numerical value; and
obtaining a result by comparing the first message authentication code and the second message authentication code,
wherein the process step of generating the second message authentication code includes process steps of:
generating disturbance information by using the temporary use numerical value;
calculating a conversion message from the message; and
calculating the second message authentication code from the disturbance information and the conversion message.

10. A message authentication system, comprising:
a message authentication code generating device for calculating a first message authentication code for a message from the message; and
a message authentication code verification device for verifying authenticity of the message based on the message and the first message authentication code for verifying the authenticity of the message sent from the message authentication code generating device,
wherein, as the process for generating the first message authentication code from the message and a temporary use numerical value, the message authentication code generating device executes process steps of:
generating disturbance information by using the temporary use numerical value;
calculating a conversion message from the message; and
calculating the first message authentication code from the disturbance information and the conversion message, and
as the process for generating a second message authentication code from the message and the temporary use numerical value, the message authentication code verification device executes process steps of:
generating the disturbance information by using the temporary use numerical value;
calculating the conversion message from the message; and
calculating the second message authentication code from the disturbance information and the conversion message, and
a process of obtaining a result by comparing the first message authentication code and the second message authentication code is performed.
